(19) United States
(12) Patent Application Publication
(10) Pub. No.: US 2007/0202882 A1
(43) Pub. Date: Aug. 30, 2007

(54) Method and system for ranging in communication system

(75) Inventors: Hyeong-Jong Ju, Suwon-si (KR); Dong-Oh Hwang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/703,594

(22) Filed: Feb. 7, 2007

(30) Foreign Application Priority Data
Feb. 7, 2006 (KR) 11662/2006

(51) Int. Cl. H04Q 7/20

(52) U.S. Cl. 455/450

(57) ABSTRACT

A method is provided a ranging method in a communication system. The method includes measuring the state of a channel between an Mobile Station (MS) and a Base Station (BS) when recognizing a need for ranging with the BS after acquiring synchronization with the BS; setting a channel state information code corresponding to the measured channel state; and transmitting a ranging code message including the set channel state information code to the BS to perform the ranging.

### PRIORITY

This application claims the benefit under 35 U.S.C. § 119(a) of a Korean Patent Application filed in the Korean Intellectual Property Office on Feb. 7, 2006 and assigned Serial No. 2006-11662, the entire disclosure of which is incorporated herein by reference.

### BACKGROUND OF THE INVENTION

1. Field of the Invention

The present invention generally relates to a communication system, and in particular, to a ranging method and system for efficiently using limited radio resources using channel state information.

2. Description of the Related Art

Recently, extensive research is being conducted for next generation systems in order to provide subscribers with services having various qualities-of-service (QoS) at higher transmission speeds. In particular, research is being actively conducted in relation to the next generation communication systems in order to provide high speed services through Broadband Wireless Access (BWA) systems, such as wireless Local Area Network (LAN) communication systems and wireless Metropolitan Area Network (MA) communication systems, while ensuring the mobility of the BWA communication systems. Representative communication systems are based on an Institute of Electrical and Electronics Engineers (IEEE) 802.16a/c and an IEEE 802.6c.

An IEEE 802.16a/d based communication system and an IEEE 802.6e based communication system, BWA communication systems, employ Orthogonal Frequency Division Multiplexing (OFDM)/Orthogonal Frequency Division Multiple Access (OFDMA) schemes in order to provide a broadband transport network for a physical channel of the wireless MAN system. The IEEE 802.16a/d communication system is limited to a fixed state of a Subscriber Station (SS), i.e., does not consider the mobility of an SS, and considers a single cell structure. In contrast, the IEEE 802.16e communication system adds consideration of the mobility of an SS to the IEEE 802.16a/d communication system. Hereinafter, an SS having mobility will be referred to as a Mobile Station (MS).

The BWA communication system requires a ranging process for adjusting a correct time offset between a transmitter, e.g., an MS, and a receiver, e.g., a Base Station (BS), and for controlling power in an UpLink (UL). The ranging process can be classified into initial ranging, bandwidth request ranging, and periodic ranging.

The initial ranging is performed after a BS request in order to acquire synchronization between the BS and the MS. The initial ranging is performed to set a correct time offset and control transmission power between the MS and the BS. In other words, the MS performs the initial ranging in order to receive, upon its power-on, system information broadcast from the BS after acquiring a DownLink (DL) synchronization, and then control the time offset and transmission power with the BS in the UL.

In addition, the periodic ranging is performed periodically by the MS which has controlled the time offset and transmission power with the BS through the initial ranging in order to adjust a channel state with the BS. The bandwidth request ranging is performed by the MS which has controlled the time offset and transmission power with the BS through the initial ranging in order to request a bandwidth for actual communication with the BS.

A ranging channel is composed of one or more sub-channels and exists in a UL interval. The initial ranging, the periodic ranging, and the bandwidth request ranging are performed through the ranging channel. For the initial ranging, the MS selects one of a plurality of preset ranging codes and transmits the selected ranging code to the BS.

FIG. 1 illustrates the structure of a general IEEE 802.16e communication system.

Referring to FIG. 1, the IEEE 802.16e communication system has a multi-cell structure and includes a BS 101 that manages a single cell 100 out of multiple cells and a plurality of MSs that receive communication services from the BS 101, i.e., MS1 103, MS2 105, MS3 107, MS4 109, and MS5 111. Signal transmission/reception between the BS 101 and the MSs 103, 105, 107, 109, and 111 are performed using OFDM/OFDMA.

In the IEEE 802.16e communication system having a frame structure, the BS 101 efficiently allocates the resources of each frame to the MSs 103, 105, 107, 109, and 111 and resource allocation information is transmitted to the MSs 103, 105, 107, 109, and 111 through a MAP message. A MAP message carrying DL resource allocation information is a DL-MAP message and a MAP message carrying UL resource allocation information is a UL-MAP message.

Upon transmission of the DL resource allocation information through the DL-MAP message and the UL resource allocation information through the UL-MAP message from the BS 101, the MSs 103, 105, 107, 109, and 111 decode the received DL-MAP message and UL-MAP message in order to detect resource allocation position information about the positions of the resources allocated to the MSs 103, 105, 107, 109, and 111 and control information of data to be received by the MSs 103, 105, 107, 109, and 111. The MSs 103, 105, 107, 109, and 111 can receive or transmit data through the DL or the UL using the detected resource allocation position information and control information.

The MSs 103, 105, 107, 109, and 111 in the cell 100 of the IEEE 802.16e communication system have different propagation environments, i.e., different channel states, during data transmission/reception with the BS 101. In the IEEE 802.16e communication system, channel information between the BS 101 and the MSs 103, 105, 107, 109, and 111 according to the different propagation environments is classified into UL channel information and DL channel information. The UL channel information and DL channel information are defined using a Type/Length/Value (TLV) format and are then transmitted to the MSs 103, 105, 107, 109, and 111 through a DL Channel Descriptor (DCD) message and a UL Channel Descriptor (UCD) message at predetermined intervals, thereby providing channel characteristic information to the MSs 103, 105, 107, 109, and 111.

For example, if, among the MSs 103, 105, 107, 109, and 111, the MS1 103 is in the best propagation environment, i.e., the best channel state, and the MS5 111 is in the worst channel state, the BS 101 receives channel state information from the MSs 103, 105, 107, 109, and 111 and allocates resources to the MSs 103, 105, 107, 109, and 111 using a Modulation and Coding Scheme (MCS) according to the received channel state information. Since the amount of resources required by the MSs 103, 105, 107, 109, and 111 are different from one another depending on the channel state information, the BS 101 allocates the required resources to the MSs 103, 105, 107, 109, and 111 using different MCS levels. In other words, the BS 101 allocates the smallest amount of resources to the MS1 103 in the best channel state and the largest amount of resources to the MS5 111 in the worst channel state.

FIG. 2 is a signaling diagram illustrating a ranging process of a general IEEE 802.16e communication system.

Referring to FIG. 2, an MS 201, upon its power-on, monitors all frequency bands preset by the MS 201 in order to detect a reference signal, e.g., a pilot signal, having the strongest intensity, e.g., the greatest Carrier-to-Interference and Noise Ratio (CINR). The MS 201 determines a BS 203 having transmitted the pilot signal having the greatest CINR as the BS 203 currently covering the MS 201, and acquires system synchronization with the BS 203 by receiving a preamble of a DL frame transmitted from the BS 203.

Once the MS 201 acquires system synchronization with the BS 203, the BS 203 transmits a UL-MAP message to the MS 201 in step 211. The UL-MAP message includes a plurality of parameters, i.e., Information Elements (IEs) such as Management Message Type indicating the type of a transmission message, UL Channel ID indicating a using UL channel ID, UCD count indicating a count corresponding to a configuration change in a UCD message including a UL burst profile, and Number of UL-MAP Elements n indicating the number of elements following UCD count. UL Channel ID is allocated in a Media Access Control (MAC)-sublayer.

The MS 201 having acquired system synchronization with the BS 203, i.e., having recognized DL and UL control information and actual data transmission/reception positions, transmits a ranging code (Ranging-Code) message to the BS 203 in step 213. The ranging code message is a message for requesting initial ranging and is transmitted in a ranging area set in the UL-MAP message by the BS 203. The BS 203 then transmits a Ranging Response (RNG-RSP) message including information required for frequency/timing/transmission power compensation for the ranging process to the MS 203 in response to the ranging code message in step 215. The RNG-RSP message includes a plurality of IEs, i.e., Management Message Type indicating the type of a transmission message and UL Channel ID indicating a UL channel ID.

The completion of the transmission/reception of the RNG-RSP message, i.e., the completion of the ranging process, can be determined by a value set in a Ranging Status field included in TLV encoded information of the RNG-RSP message. If the BS 203 recognizes a need for additional ranging with the MS 201 because frequency/timing/transmission power information do not exist within a predetermined range, the BS 203 sets the Ranging Status field of the RNG-RSP message to ‘continue’, so as to allow the MS 201 receiving the RNG-RSP message to recognize, that the ranging process continues.

The BS 203 then transmits the UL-MAP message to the MS 201 in step 217 and the MS 201 having received the UL-MAP message transmits the ranging code message to the BS 203 in step 219. The BS 203 then transmits the RNG-RSP message to the MS 201 in step 221. If the ranging process is successful with the frequency/timing/transmission power information that exist within the predetermined range, the BS 203 sets the Ranging Status field of the RNG-RSP message to ‘success’, so as to allow the MS 201 receiving the RNG-RSP message to recognize that the ranging process is successful.

The BS 203 then transmits an allocation IE message to the MS 201 in step 223 and the MS 201 having received the allocation IE message transmits a Ranging Request (RNG-REQ) message to the BS 203 in step 225. The RNG-REQ message includes a plurality of IEs, i.e., Management Message Type indicating the type of a transmission message, DL Channel ID indicating a DL channel ID included in the RNG-REQ message received by the MS 201 through the UCD message, and Pending Until Complete indicating the priority of a transmission ranging response. The BS 203 then transmits the RNG-RSP message including information required for frequency/timing/transmission power compensation for the ranging process to the MS 201 in response to the RNG-REQ message in step 227.

Although the ranging process is completed through a single transmission of the RNG-REQ message and a single transmission of the RNG-RSP message in response to the RNG-REQ message in FIG. 2 for convenience of explanation, the transmission of the RNG-REQ message and the transmission of the RNG-RSP message may be repeated a number of times until completion of frequency/timing/transmission power compensation for the UL and the ranging process is performed periodically.

Since the IEEE 802.16e communication system considers the mobility of an MS, the periodic ranging of the MS becomes a vital factor for reliable data transmission/reception. According to the periodic ranging, which is an operation for measurement and compensation of parameters required when the MS performs reliable communication with a BS, the BS needs to allocate UL resources so that the MS can perform the periodic ranging, i.e., the MS can transmit the RNG-REQ message to the BS. More specifically, the BS has to allocate the UL resources to the MS for the periodic ranging of the MS and notifies the MS of the information for allocation of the UL resources of the MS through the UL-MAP message. The MS then transmits the RNG-REQ message to the BS through the allocated UL resources and performs the periodic ranging with the BS. The BS compensates for the transmission power, timing offset, and frequency offset according to the RNG-REQ message received from the MS and transmits the RNG-RSP message to the MS in response to the RNG-REQ message, thereby completing the periodic ranging.

However, in the current IEEE 802.16e communication system, during the ranging process using a ranging code message, a BS cannot know the channel state of an MS. Thus, the BS allocates resources to the MS on the assumption that the MS is in the worst channel state and transmits an RNG-RSP message to the MS through the allocated resources. As a result, when the BS transmits the RNG-RSP message to an MS in the best channel state, resources are wasted because the BS allocates resources to the MS on the assumption that the MS is in the worst channel state. Moreover, the ranging process is performed periodically in the IEEE 802.16e communication system, wasting even further resources.

### SUMMARY OF THE INVENTION

An aspect of the present invention is to address at least the above problems and/or disadvantages and to provide at least the advantages described below. Accordingly, an aspect of the present invention is to provide a ranging method and system in a communication system.

Another aspect of the present invention is to provide a ranging method and system using channel state information in a communication system.

According to another aspect of the present invention, there is provided a ranging method in a communication system. The method includes measuring the state of a channel between a Mobile Station (MS) and a Base Station (BS) when recognizing a need for ranging with the BS after acquiring synchronization with the BS; setting a channel state information code corresponding to the measured channel state; and transmitting a ranging code message including the set channel state information code to the BS to perform the ranging.

According to another aspect of the present invention, there is provided a method for ranging in a communication system. The method includes transmitting resource allocation information to a Mobile Station (MS) when acquiring synchronization with the MS; receiving a ranging code message including channel state information from the MS using allocated resources; allocating resources to the MS according to the received ranging code message; and transmitting a ranging response message using the allocated resources to perform ranging.

According to another aspect of the present invention, there is provided a system for ranging in a communication system. The system includes a Mobile Station (MS) for measuring the state of a channel between MS and a Base Station (BS) when recognizing a need for ranging with the BS after acquiring synchronization with the BS, setting a channel state information code corresponding to the measured channel state, and transmitting a ranging code message including the set channel state information code to the BS to perform the ranging; and the BS for allocating resources to the MS according to the received ranging code message when receiving the ranging code message from the MS, and transmitting a ranging response message using the allocated resources.

### BRIEF DESCRIPTION OF THE DRAWINGS

The above and other features and advantages of a the present invention will be more apparent from the following detailed description taken in conjunction with the accompanying drawings, in which:

FIG. 1 illustrates the structure of a general Institute of Electrical and Electronics Engineers (IEEE) 802.16e communication system;

FIG. 2 is a signaling diagram illustrating a ranging process of a general IEEE 802.16e communication system;

FIG. 3 is a flowchart illustrating an operation of a Mobile Station (MS) in a communication system according to the present invention;

FIG. 4 is a flowchart illustrating an operation of a Base Station (BS) in a communication system according to the present invention;

FIG. 5 is a flowchart illustrating an operation of an MS in a communication system according to the present invention;

FIG. 6 is a flowchart illustrating an operation of a BS in a communication system according to the present invention;

FIG. 7 is a signaling diagram illustrating a periodic ranging process in a communication system according to the present invention;

FIG. 8 is a signaling diagram illustrating a bandwidth request ranging process in a communication system according to the present invention; and

FIG. 9 is a signaling diagram illustrating a handover ranging process in a communication system according to the present invention.

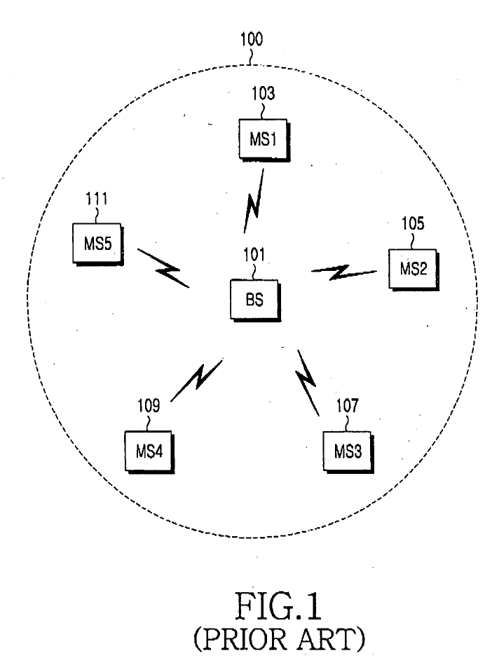

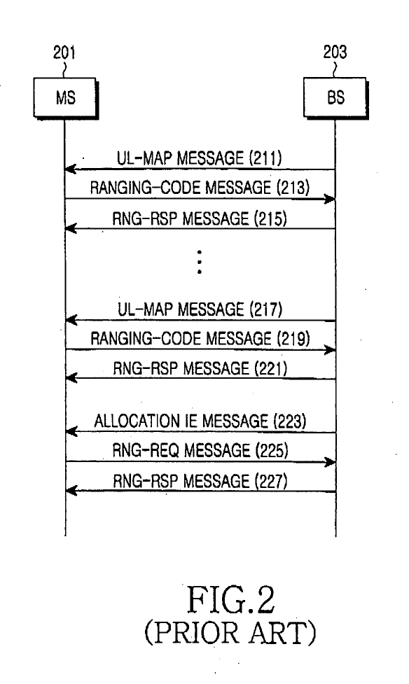

### DETAILED DESCRIPTION OF THE PREFERRED EMBODIMENT

The matters defined in the description such as a detailed construction and elements are provided to assist in a comprehensive understanding of the present invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a method and system for ranging in a communication system, e.g., an Institute of Electrical and Electronics Engineers (IEEE) 802.16 communication system, that is a Broadband Wireless Access (BWA) communication system. Although an IEEE 802.16 communication system using Orthogonal Frequency Division Multiplexing (OFDM)/Orthogonal Frequency Division Multiple Access (OFDMA) schemes will be used as an example in an exemplary embodiment of the present invention to be described, the ranging method and system of the present invention can also be applied to other types of communication systems.

The present invention also provides a ranging method and system between a transmitter managing multiple cells, e.g., a Base Station (BS), and a receiver receiving a communication service from the transmitter, e.g., a Mobile Station (MS), in a communication system having a multi-cell structure. The BS performs a ranging operation with the MS using a ranging code according to channel state information transmitted from the MS, e.g., a ratio of carrier received from the BS to interference and noise, e.g., Carrier-to-Interference and Noise Ratio (CINR), or the intensity of a reception signal.

A communication system according to the present invention classifies channel information between a BS and an MS into UpLink (UL) channel information and DownLink (DL) channel information, defines the UL channel information and DL channel information using a Type/LengthNalue (TLV) format, and transmits the UL channel information and DL channel information to all the MSs through a DL Channel Descriptor (DCD) message and a UL Channel Descriptor (UCD) message at predetermined intervals, thereby providing channel characteristic information to all the MSs.

A communication system according to the present invention to be described below performs ranging for adjusting a correct time offset between an MS and a BS and controlling transmission power in a UL. The ranging can be classified into initial ranging, bandwidth request ranging, and periodic ranging. The initial ranging is performed after a BS request in order to acquire synchronization between the BS and the MS. The initial ranging is performed to set a correct time offset and control transmission power between the MS and the BS. In other words, the MS performs the initial ranging in order to receive, upon its power-on, system information broadcast from the BS after acquiring DL synchronization and then control the time offset and transmission power with the BS in the UL.

In addition, the periodic ranging is performed periodically by the MS which has controlled the time offset and transmission power with the BS through the initial ranging in order to adjust a channel state with the BS. The bandwidth request ranging is performed by the MS which has controlled the time offset and transmission power with the BS through the initial ranging in order to request a bandwidth for actual communication with the BS. A ranging channel is composed of one or more sub-channels and exists in a UL interval. The initial ranging, the periodic ranging, and the bandwidth request ranging are performed through the ranging channel. For the initial ranging, the MS selects one of a plurality of preset ranging codes and transmits the selected ranging code to the BS.

A UCD message transmitted from a BS to an MS in a communication system according to the present invention will be described with reference to Table 1. Table 1 shows the format of a UCD message including UL channel information.

TABLE 1

| | | Length | |
|---|---|---|---|
| Name | Type | (Byte) | Value |
| Initial_Ranging-Code | 150 | 1 | |
| Periodic_Ranging-Code | 151 | 1 | |
| BW_REQ_Ranging-Code | 152 | 1 | |
| HO_Ranging-Code | 194 | 1 | |
| DL_CH_Info_Initial_Ranging-Code | 200 | 2 | 1 Byte: Channel Information Code |
| | | | 1 Byte: Number of Ranging Codes |
| DL_CH_Info_Periodic_Ranging-Code | 201 | 2 | 1 Byte: Channel Information Code |
| | | | 1 Byte: Number of Ranging Codes |
| DL_CH_Info_BW_REQ_Ranging-Code | 202 | 2 | 1 Byte: Channel Information Code |
| | | | 1 Byte: Number of Ranging Codes |
| DL_CH_Info_HO_Ranging-Code | 203 | 2 | 1 Byte: Channel Information Code |
| | | | 1 Byte: Number of Ranging Codes |
| UL_CH_Info_Initial_Ranging-Code | 204 | 2 | 1 Byte: Channel Information Code |
| | | | 1 Byte: Number of Ranging Codes |
| UL_CH_Info_Periodic_Ranging-Code | 205 | 2 | 1 Byte: Channel Information Code |
| | | | 1 Byte: Number of Ranging Codes |
| UL_CH_Info_BW_REQ_Ranging-Code | 206 | 2 | 1 Byte: Channel Information Code |
| | | | 1 Byte: Number of Ranging Codes |
| UL_CH_Info_HO_Ranging-Code | 207 | 2 | 1 Byte: Channel Information Code |
| | | | 1 Byte: Number of Ranging Codes |

As can be seen from Table 1, in the communication system according to the present invention, the UCD message includes an Initial_Ranging-Code field including information of a channel defined to allow an MS to transmit an initial ranging code message for requesting initial ranging, a Periodic_Ranging_Code field including information of a channel defined to allow the MS to transmit a periodic ranging code message for requesting periodic ranging, a BW_REQ_Ranging-Code field including information of a channel defined to allow the MS to transmit a bandwidth request ranging code message for requesting bandwidth request ranging, and an HO_Ranging-Code field including information of a channel defined to allow the MS to transmit a handover ranging code message for requesting handover ranging when the MS attempts a handover to a neighbor cell.

The UCD message includes fields including information of a channel defined to allow the MS to transmit DL channel state information and UL channel state information for transmission of those ranging codes, i.e., a DL_CH_Info_Initial_Ranging-Code field, a DL_CH_Info_Periodic_Ranging-Code field, DL_CH_Info_BW_REQ_Ranging-Code field, a DL_CH_Info_HO_Ranging-Code field, a UL_CH_Info_Initial Ranging-Code field, a UL_CH_Info_Periodic_Ranging-Code field, a UL_CH_Info_BW_REQ_Ranging-Code field, and a UL_CH_Info_HO_Ranging-Code field. Each of the fields that include the information of the channel defined to allow transmission of the DL channel state information and the UL channel state information is composed of 2 bytes, one of which indicates a code of the DL channel state information and the UL channel state information and the other of which indicates a ranging code. The code of channel state information and the ranging code will be described in more detail with reference to Table 2 and Table 3.

In Table 2, each of a DL channel state and a UL channel state is classified into 5 types and a channel state information code and a Modulation and Coding Scheme (MCS) code corresponding to each type are shown. Table 3 shows examples of values set in each ranging code field of Table 1.

TABLE 2

| | Channel state | |
|---|---|---|
| Channel state | information code | MCS code |
| Worst | 0 | 0 |
| Poor | 1 | 1 |
| Normal | 2 | 2 |
| Good | 3 | 3 |
| Best | 4 | 4 |

TABLE 3

| | Ranging | Channel state |
|---|---|---|
| Name | code | information code |
| Initial_Ranging-Code | 0-3 | 0 |
| Periodic_Ranging-Code | 4-7 | 0 |
| BW_REQ_Ranging-Code | 8-11 | 0 |
| HO_Ranging-Code | 12-15 | 0 |
| DL_CH_Info_Periodic_Ranging-Code | 18, 19 | 4 |
| DL_CH_Info_HO_Ranging-Code | 20, 21 | 4 |
| UL_CH_Info_BW_REQ_Ranging-Code | 22, 23 | 4 |
| UL_CH_Info_HO_Ranging-Code | 24, 25 | 4 |

As can be seen from Table 2, when the state of a DL or UL channel between a BS and an MS is at its worst, a channel state information code is set to a predetermined value, e.g., ‘0’, to indicate that the channel state is at its worst. The greatest amount of resources needs to be allocated to an MS in the worst channel state and an MCS code indicating an MCS for allocating the greatest amount of resources is set to a predetermined value, e.g., ‘0’.

When the state of the DL or UL channel is at its best, the channel state information code is set to a predetermined value, e.g. ‘4’ to indicate that the channel state is at its best. The least amount of resources needs to be allocated to an MS in the best channel state and an MSC code indicating an MCS for allocating the greatest amount of resources is set to a predetermined value, e.g., ‘4’. In this way, a channel state information code corresponding to each channel state is set and an MCS code for allocating resources through an MCS corresponding to each channel state is set.

As can be seen from Table 3, a ranging code and a channel state information code are set through a channel defined by fields of a UCD message according to the present invention. For example, a ranging code ‘18’ indicates periodic ranging and a channel state information code ‘4’ indicates that a small amount of resources may be allocated because a DL channel is in the best state in the case of the periodic ranging and data can be stably received although being transmitted using resources allocated through an MCS corresponding to an MCS code ‘4’. A ranging code ‘22’ indicates bandwidth request ranging and a channel state information code ‘4’ indicates that a small amount of resources may be allocated because a UL channel is in the best state in the case of the bandwidth request ranging and data can be stably received although being transmitted using resources allocated through an MCS corresponding to an MCS code ‘4’.

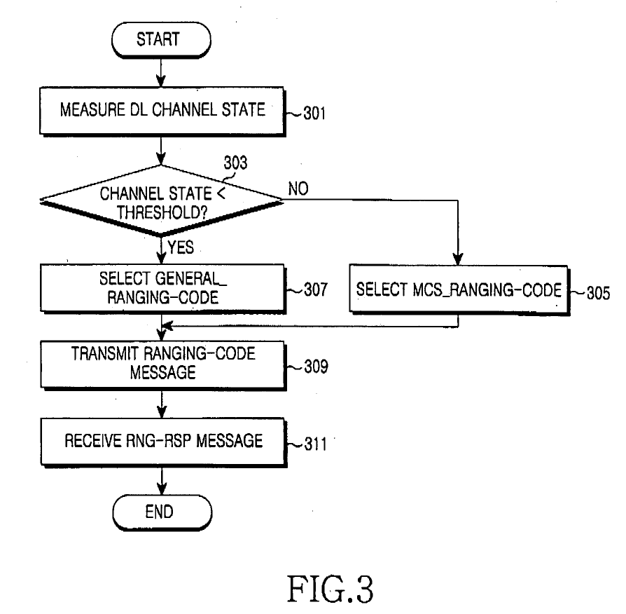

FIG. 3 is a flowchart illustrating an operation of an MS in a communication system according to the present invention during transmission of a ranging code message including DL channel state information through a channel defined by fields of a UCD message shown in Table 1.

Referring to FIG. 3, the MS measures the state of a DL channel with a BS that manages a cell of the MS, e.g., a CINR from the BS, or the intensity of a reception signal in step 301 and compares the measured channel state with a threshold in step 303. The threshold can be preset by either a user or system controlled. If the measured channel state is less than the threshold, it means that the DL channel is in the worst state. Thus, the MS goes to step 307 to select a general ranging code. In other words, since the DL channel is in the worst state in step 307, the greatest amount of resources is required for stable data transmission/reception and thus the MS accordingly selects the general ranging code like when the MS selects a ranging code on the assumption that the DL channel is in the worst state as described with reference to the prior art. For example, since the DL channel is in the worst state in step 307, the MS sets a channel state information code indicating the state of the DL channel in Table 3 to ‘0’.

If the measured channel state is greater than or equal to the threshold in step 301, it means that the DL channel is not in the worst state. Thus, the MS goes to step 305 to select an MCS ranging code as described with reference to Table 1, Table 2, and Table 3. For example, if the DL channel is in the best state in step 305, the MS sets the channel state information code indicating the state of the DL channel in Table 3 to ‘4’.

Next, the MS transmits a ranging code (Ranging-Code) message including the selected and set ranging code information to the BS in step 309 and receives a Ranging Response (RNG-RSP) message from the BS in response to the ranging code message for ranging in step 311. The ranging code message requests predetermined ranging, i.e., one of initial ranging, periodic ranging, bandwidth request ranging, and handover ranging through a channel defined by fields of Table 1 and a ranging code indicating DL channel state information is set according to the requested ranging.

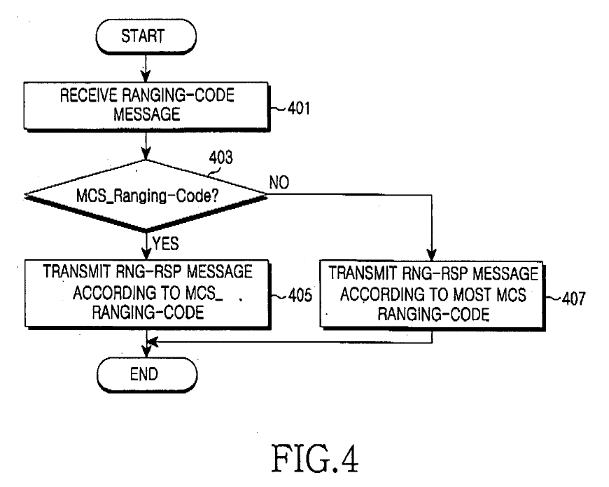

FIG. 4 is a flowchart illustrating an operation of a BS in a communication system according to the present invention when an MS transmits a ranging code (Ranging-Code) message including DL channel state information through a channel defined by fields of a UCD message shown in Table 1.

Referring to FIG. 4, upon reception of a ranging code message in which a ranging code is set as mentioned above from the MS in step 401, the BS determines if the set ranging code is an MCS ranging code in step 403. If the set ranging code is not an MCS ranging code, it means that a DL channel is in the worst state and thus the BS transmits an RNG-RSP message to the MS according to a ranging code corresponding to the most MCS level. Since the DL channel is in the worst state and thus requires the greatest amount of resources for stable data transmission/reception, the BS allocates the greatest amount of resources according to the ranging code corresponding to the most MCS level and transmits the RNG-RSP message to the MS.

If the ranging code is an MCS ranging code, it means that the DL channel is not in the worst state. Thus, the BS transmits an RNG-RSP message to the MS according to the MCS ranging code. Since the DL channel is not in the worst state, the BS allocates resources according to an MCS code set in the MCS ranging code and transmits the RNG-RSP message to the MS.

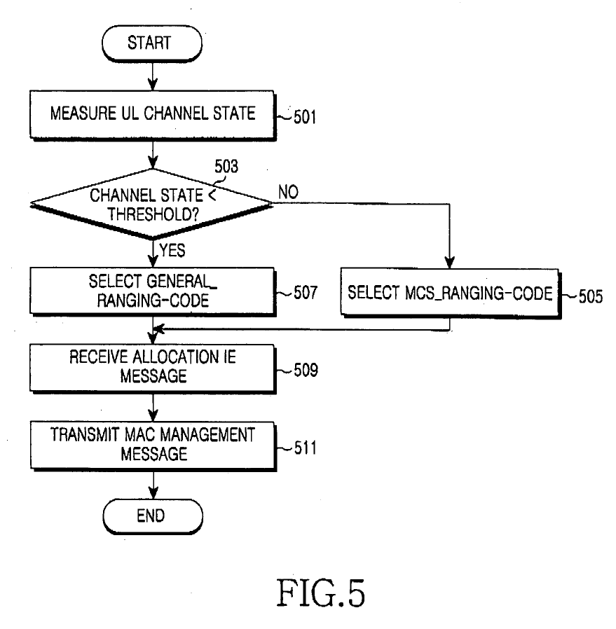

FIG. 5 is a flowchart illustrating an operation of an MS in a communication system according to the present invention during transmission of a ranging code message including UL channel state information through a channel defined by fields of a UCD message shown in Table 1.

Referring to FIG. 5, the MS in step 501 measures the state of a UL channel with a BS managing a cell including the MS and in step 503 compares the measured channel state with a threshold. Again, the threshold can be preset by a user or system controlled. The measurement of the UL channel state is performed using the measured DL channel state information, e.g., the CINR, from the BS or the intensity of a reception signal. If the measured channel state is less than the threshold in step 503, it means that the UL channel is in the worst state and thus the MS goes to step 507 to select a general ranging code.

Since the UL channel is in the worst state in step 507 and thus requires the greatest amount of resources for stable data transmission/reception, the MS selects a general ranging code like when the MS selects a ranging code on the assumption that the UL channel is in the worst state as described with reference to the prior art. For example, since the UL channel is in the worst state in step 507, the MS sets a channel state information code indicating the state of the UL channel in Table 3 to ‘0’.

If the measured channel state is greater than or equal to the threshold, it means that the UL channel is not in the worst state. Therefore, the MS goes to step 505 to select an MCS ranging code as described with reference to Table 1, Table 2, and Table 3. For example, if the UL channel is in the best state in step 505, the MS sets a channel state information code indicating the UL channel state in Table 3 to ‘4’.

The MS then transmits a ranging code (Ranging-Code) message including the selected and set ranging code information to the BS. After being allocated resources by the BS according to the transmitted ranging code message in step 509, the MS receives a resource allocation Information Element (IE) message including a plurality of lEs as a plurality of parameters of the allocated resources. The MS then transmits a Media Access Control (MAC) management message to the BS through the allocated resources in step 511.

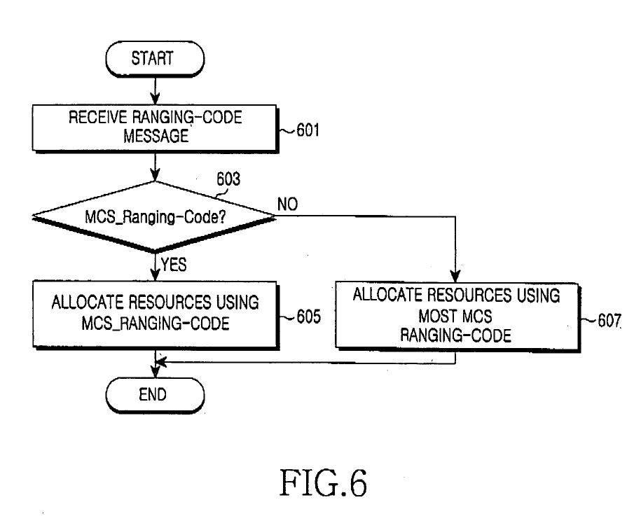

FIG. 6 is a flowchart illustrating an operation of a BS in a communication system according to the present invention when an MS transmits a ranging code (Ranging-Code) message including UL channel state information through a channel defined by fields of a UCD message shown in Table 1.

Referring to FIG. 6, upon reception of a ranging code message in which a ranging code is set as mentioned above from the MS in step 601, the BS determines if the ranging code set in the ranging code message is an MCS ranging code (MCS_Ranging-Code) in step 603. If the ranging code is not an MCS ranging code, it means that a UL channel is in the worst state and thus the BS allocates resources to the MS using a ranging code corresponding to the most MCS level. Since the UL channel is in the worst state and thus requires the greatest amount of resources for stable data transmission/reception, the BS allocates the greatest amount of resources to the MS using the ranging code corresponding to the most MCS level.

If the ranging code is an MCS ranging code, it means that the UL channel is not in the worst state and thus the BS allocates to the MS using the MCS ranging code. Since the UL channel is not in the worst state, the BS allocates resources to the MS according to an MCS code set in the MCS ranging code.

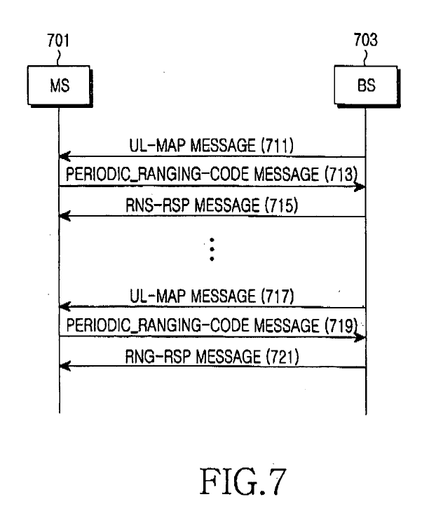

FIG. 7 is a signaling diagram illustrating a periodic ranging process in a communication system according to the present invention.

Referring to FIG. 7, an MS 701, upon its power-on, monitors all frequency bands preset by the MS 701 in order to detect a reference signal, e.g., a pilot signal, having the strongest intensity, e.g., the greatest CINR. The MS 701 determines a BS 703 having transmitted the pilot signal having the greatest CINR as the BS 703 currently covering the MS 701, and acquires system synchronization with the BS 703 by receiving a preamble of a DL frame transmitted from the BS 703.

Once the MS 701 acquires system synchronization with the BS 703, the BS 703 transmits a UL-MAP message to the MS 701 in step 711. The UL-MAP message includes a plurality of IEs such as Management Message Type indicating the type of a transmission message, UL Channel ID indicating a using UL channel ID, UCD count indicating a count corresponding to a configuration change in a UCD message including a UL burst profile, and Number of UL-MAP Elements n indicating the number of elements following UCD count. UL Channel ID is allocated in a MAC-sublayer.

The MS 701 having acquired system synchronization with the BS 703, i.e., having recognized DL and UL control information and actual data transmission/reception positions, transmits a periodic ranging code (Periodic_Ranging-Code) message to the BS 703 in step 713. The periodic ranging code message is a message for requesting periodic ranging and is transmitted in a ranging area set in the UL-MAP message by the BS 703. If the measured state of a DL channel is in the best state as described with reference to FIG. 3, a ranging code ‘18’ or ‘19’ and a channel state information code ‘4’ of the DL_CH_Info_Periodic_Ranging-Code field shown in Table ˜3 are transmitted. If the measured state of a UL channel is in the best state as described with reference to FIG. 5, a ranging code ‘22’ or ‘23’ and a channel state information code ‘4’ of the UL_CH_Info_Periodic_Ranging-Code field shown in Table 3 are transmitted.

The BS 703 then transmits a Ranging Response (RNG-RSP) message including information required for frequency/timing/transmission power compensation for the ranging process to the MS 703 in response to the ranging code message in step 715. The RNG-RSP message includes a plurality of IEs, i.e., Management Message Type indicating the type of a transmission message and UL Channel ID indicating a UL channel ID.

The completion of the transmission/reception of the RNG-RSP message, i.e., the completion of the ranging process, can be determined by a value set in a Ranging Status field included in TLV encoded information of the RNG-RSP message. If the BS 703 recognizes a need for additional ranging with the MS 701 because frequency/timing/transmission power information do not exist within a predetermined range, the BS 703 sets the Ranging Status field of the RNG-RSP message to ‘continue’, so as to allow the MS 701 receiving the RNG-RSP message to recognize that the ranging process continues. The BS 703 allocates resources to the MS 701 using an MCS corresponding to a channel state information code included in the periodic ranging code message and transmits the RNG-RSP message to the MS 701 using the allocated resources.

The BS 703 then transmits the UL-MAP message to the MS 701 in step 717 and the MS 701 having received the UL-MAP message transmits the periodic ranging code message to the BS 703 in step 719. The BS 703 then transmits the RNG-RSP message to the MS 701 in step 721. If the ranging process is successful with the frequency/timing/transmission power information that exist within the predetermined range, the BS 703 sets the Ranging Status field of the RNG-RSP message to ‘success’, so as to allow the MS 701 receiving the RNG-RSP message to recognize that the ranging process is successful.

Although ‘single continue’ is set in the Ranging Status field of the RNG-RSP message and the MS 701 having received the RNG-RSP message continues the ranging process in FIG. 7 for convenience of explanation, the ranging process may be repeated a number of times until the completion of the frequency/timing/transmission power compensation for the UL and the ranging process is performed periodically.

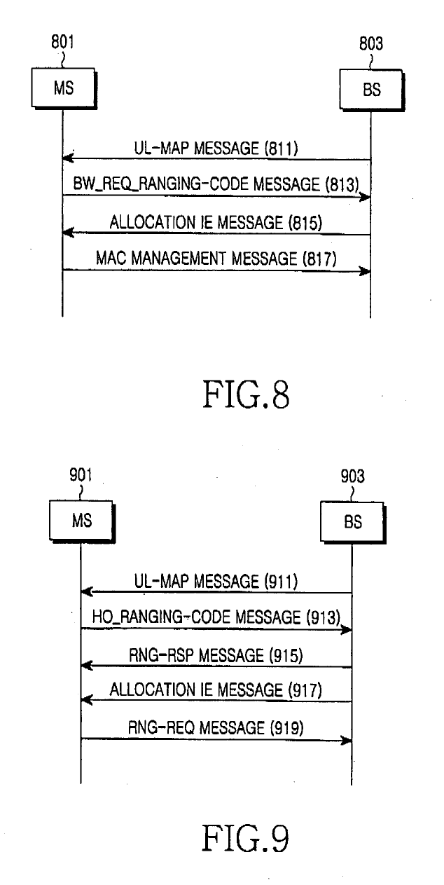

FIG. 8 is a signaling diagram illustrating a bandwidth request ranging process in a communication system according to the present invention.

Referring to FIG. 8, an MS 801, upon its power-on, monitors all frequency bands preset by the MS 801 in order to detect a reference signal, e.g., a pilot signal, having the strongest intensity, e.g., the greatest CINR. The MS 801 determines a BS 803 having transmitted the pilot signal having the greatest CINR as the BS 803 currently covering the MS 801, and acquires system synchronization with the BS 803 by receiving a preamble of a DL frame transmitted from the BS 803.

Once the MS 801 acquires system synchronization with the BS 803, the BS 803 transmits a UL-MAP message to the MS 801 in step 811. The UL-MAP message includes a plurality of IEs such as Management Message Type indicating the type of a transmission message, UL Channel ID indicating a using UL channel ID, UCD count indicating a count corresponding to a configuration change in a UCD message including a UL burst profile, and Number of UL-MAP Elements n indicating the number of elements following UCD count. UL Channel ID is allocated in a MAC-sublayer.

The MS 801 having acquired system synchronization with the BS 803, i.e., having recognized DL and UL control information and actual data transmission/reception positions, transmits a bandwidth request ranging code (BW_REQ_Ranging-Code) message to the BS 803 in step 813. The bandwidth request ranging code message is a message for requesting bandwidth request ranging and is transmitted in a ranging area set in the UL-MAP message by the BS 803. If the measured state of a DL channel is in the best state as described with reference to FIG. 3, a ranging code and a channel state information code of the DL_CH_Info_BW_REQ_Ranging-Code field shown in Table 1 are transmitted. If the measured state of a UL channel is in the best state as described with reference to FIG. 5, a ranging code and a channel state information code of the UL_CH_Info_BW_REQ_Ranging-Code field shown in Table 1 are transmitted.

After the BS 803 allocates resources to the MS 801 according to the bandwidth request ranging code message, the BS 803 transmits an allocation IE message including IEs as parameters of the allocated resources to the MS 801 in step 815. The MS 801 then transmits a MAC management message to the BS 803 using the allocated resources in step 817.

FIG. 9 is a signaling diagram illustrating a handover ranging process in a communication system according to the present invention.

Referring to FIG. 9, when an MS 901 moves to an adjacent cell while receiving a communication service from a BS that manages a cell including the MS 901, the MS 901 monitors all frequency bands preset by the MS 901 in order to detect a reference signal, e.g., a pilot signal, having the strongest intensity, e.g., the greatest CINR. The MS 901 determines a BS 903 having transmitted the pilot signal having the greatest CINR as the BS 803 currently covering the MS 901, and acquires system synchronization with the BS 903 by receiving a preamble of a DL frame transmitted from the BS 903.

Once the MS 901 acquires system synchronization with the BS 903, the BS 903 transmits a UL-MAP message to the MS 901 in step 911. The UL-MAP message includes a plurality of IEs such as Management Message Type indicating the type of a transmission message, UL Channel ID indicating a using UL channel ID, UCD count indicating a count corresponding to a configuration change in a UCD message including a UL burst profile, and Number of UL-MAP Elements n indicating the number of elements following UCD count. Only UL Channel ID is allocated in a MAC-sublayer.

The MS 901 having acquired system synchronization with the BS 903, i.e., having recognized DL and UL control information and actual data transmission/reception positions, transmits a handover ranging code (HO_Ranging-Code) message to the BS 903 in step 913. The handover ranging code message is a message for requesting handover ranging and is transmitted in a ranging area set in the UL-MAP message by the BS 903. If the measured state of a DL channel is in the best state as described with reference to FIG. 3, a ranging code and a channel state information code of the DL_CH_Info_HO_Ranging-Code field shown in Table 1 are transmitted. If the measured state of a UL channel is in the best state as described with reference to FIG. 5, a ranging code and a channel state information code of the UL_CH_Info_HO_Ranging-Code field shown in Table 1 are transmitted.

The BS 903 then transmits an RNG-RSP message including information required for frequency/timing/transmission power compensation for the handover ranging process to the MS 901 in response to the handover ranging code message in step 915. The RNG-RSP message includes a plurality of IEs, i.e., Management Message Type indicating the type of a transmission message and UL Channel ID indicating a UL channel ID. After the BS 903 allocates resources to the MS 901, the BS 903 transmits an allocation IE message including IEs as parameters of the allocated resources to the MS 901 in step 917. The MS 901 then transmits a Ranging Request (RNG-REQ) message to the BS 903 using the allocated resources in step 919. The RNG-REQ message includes a plurality of IEs, i.e., Management Message Type indicating the type of a transmission message, DL Channel ID indicating a DL channel ID included in the RNG-REQ message received by the MS 901 through the UCD message, and Pending Until Complete indicating the priority of a transmission ranging response. Although not shown in FIG. 9, the BS 903 then transmits the RNG-RSP message including information required for frequency/timing/transmission power compensation for the ranging process to the MS 901 in response to the RNG-REQ message.

Although the ranging process is completed through a single transmission of the RNG-REQ message and a single transmission of the RNG-RSP message in response to the RNG-REQ message in FIG. 9 for convenience of explanation, the transmission of the RNG-REQ message and the transmission of the RNG-RSP message may be repeated a number of times until completion of frequency/timing/transmission power compensation for the UL and the ranging process is performed periodically.

As described above, according to the present invention, channel state information is transmitted to a BS using a ranging code and resource allocation and ranging are performed using the transmitted channel state information, thereby achieving efficient use of resources and stable ranging.

While the invention has been shown and described with reference to an exemplary embodiment thereof, it will be understood by those skilled in the art that various changes in form and details may be made therein without departing from the spirit and scope of the invention.

What is claimed is:

1. A method for ranging at a Mobile Station (MS) in a communication system, the method comprising:
measuring the state of a channel between the MS and a Base Station (BS) when recognizing a need for ranging with the BS after acquiring synchronization with the BS;
setting a channel state information code corresponding to the measured channel state; and
transmitting a ranging code message including the set channel state information code to the BS to perform the ranging.

2. The method of claim 1, wherein the setting of the channel state information code comprises setting a ranging code corresponding to the ranging to be performed with the BS.

3. The method of claim 2, wherein the setting of the ranging code comprises setting an initial ranging code.

4. The method of claim 2, wherein the setting of the ranging code comprises setting a periodic ranging code.

5. The method of claim 2, wherein the setting of the ranging code comprises setting a bandwidth request ranging code.

6. The method of claim 2, wherein the setting of the ranging code comprises setting a handover ranging code.

7. The method of claim 2, wherein the setting of the ranging code comprises setting a channel information ranging code.

8. The method of claim 1, wherein the setting of the channel state information code comprises setting a Modulation and Coding Scheme (MCS) code corresponding to the measured channel state.

9. The method of claim 1, wherein the transmitting of the ranging code message and the performing of the ranging comprises being allocated resource according to the channel state information code, and receiving a ranging response message using the allocated resources.

10. The method of claim 9, wherein the being allocated resource comprises transmitting a ranging request message to the BS using the allocated resources when receiving a resource allocation information message corresponding to the allocated resources, and receiving the ranging response message in response to the ranging request message.

11. The method of claim 1, wherein the performing of the ranging comprises performing the ranging periodically.

12. A method for ranging at a Base Station (BS) in a communication system, the method comprising:
transmitting resource allocation information to a Mobile Station (MS) when acquiring synchronization with the MS;
receiving a ranging code message including channel state information from the MS using allocated resources;
allocating resources to the MS according to the received ranging code message; and
transmitting a ranging response message using the allocated resources to perform ranging.

13. The method of claim 12, wherein the receiving the ranging code message including the channel state information comprises receiving a ranging code message which a channel state information code corresponding to the channel state information is set.

14. The method of claim 13, wherein the channel state information code is a Modulation and Coding Scheme (MCS) code corresponding to the channel state information.

15. The method of claim 12, wherein the receiving of the ranging code message including the channel state information comprises receiving a ranging code message in which a ranging code corresponds to the ranging to be performed with the MS is set.

16. A system for ranging in a communication system, the system comprising:
a Mobile Station (MS) for measuring the state of a channel between the MS and a Base Station (BS) when recognizing a need for ranging with the BS after acquiring synchronization with the BS, setting a channel state information code corresponding to the measured channel state, and transmitting a ranging code message including the set channel state information code to the BS to perform the ranging; and
the BS for allocating resources to the MS according to the received ranging code message when receiving the ranging code message from the MS, and transmitting a ranging response message using the allocated resources.

17. The system of claim 16, wherein the MS sets a ranging code corresponding to the ranging to be performed with the BS.

18. The system of claim 17, wherein the MS sets an initial ranging code.

19. The system of claim 17, wherein the MS sets a periodic ranging code.

20. The system of claim 17, wherein the MS sets a bandwidth request ranging code.

21. The system of claim 17, wherein the MS sets a handover ranging code.

22. The system of claim 17, wherein the MS sets a channel information ranging code.

23. The system of claim 16, wherein the MS sets a Modulation and Coding Scheme (MCS) code corresponding to the measured channel state.

24. The system of claim 16, wherein the BS allocates the resources according to the channel state information code and transmits a ranging response message using the allocated resources.

25. The system of claim 24, wherein the MS transmits a ranging request message to the BS using the allocated resources when the MS receives a resource allocation information message corresponding to the allocated resources, and receives the ranging response message in response to the transmitted ranging request message.
